(19) United States
(12) Patent Application Publication
(10) Pub. No.: US 2024/0234786 A1
(43) Pub. Date: Jul. 11, 2024

(54) BUTTON-TYPE SECONDARY BATTERY

(71) Applicant: LG ENERGY SOLUTION, LTD., Seoul (KR)

(72) Inventors: Min Gyu KIM, Daejeon (KR); Joo Hwan SUNG, Daejeon (KR); Min Su CHO, Daejeon (KR); Geun Young PARK, Daejeon (KR)

(73) Assignee: LG ENERGY SOLUTION, LTD., Seoul (KR)

(21) Appl. No.: 18/561,385

(22) PCT Filed: Jul. 8, 2022
(86) PCT No.: PCT/KR2022/009973

§ 371 Date: Nov. 16, 2023

(30) Foreign Application Priority Data
Jul. 12, 2021 (KR) 10-2021-0091246

(51) Int. Cl. H01M 10/04; H01M 10/658; H01M 50/109; H01M 50/169; H01M 50/417; H01M 50/474

(52) U.S. Cl. CPC H01M 10/0427; H01M 10/0431; H01M 10/0468; H01M 10/658; H01M 50/109; H01M 50/169; H01M 50/417; H01M 50/474

(57) ABSTRACT

A disclosed button type secondary battery may include an electrode assembly, in which electrodes and separators are alternately disposed; a can body into which the electrode assembly is inserted, a base plate in which a through-hole is formed and which covers an opening of an upper end of the can body and is bonded to the can body, an electrode terminal of which at least a portion is inserted into the through-hole of the base plate and which covers the through-hole, an insulating gasket configured to insulate the electrode terminal and the base plate from each other, and an insulating sheet disposed on a bottom surface of the base plate to insulate the base plate and the electrode assembly from each other, wherein the bottom surface of the insulating sheet is disposed closer to the electrode assembly than a bottom surface of the electrode terminal is.

### TECHNICAL FIELD

### Cross-Reference to Related Application

The present application claims the benefit of the priority of Korean Patent Application No. 10-2021-0091246, filed on Jul. 12, 2021, which is hereby incorporated by reference in its entirety.

### TECHNICAL FIELD

The present invention relates to a button type secondary battery, and more particularly, to a button type secondary battery, in which an electrode assembly is pressed downward to improve fixability, thereby preventing the electrode assembly from being shaken in a cell, and thus, preventing a welded portion of an electrode tab from being separated, and also, since the electrode assembly is pressed downward, there is also an effect of pressing a separator wound around the electrode assembly to prevent the separator from interfering with a laser-welded portion between a can body and a base plate due to ascending of the separator.

### BACKGROUND ART

In recent years, the price of energy sources increases due to the depletion of fossil fuels, the interest in environmental pollution is amplified, and the demand for eco-friendly alternative energy sources is becoming an indispensable factor for future life. Accordingly, studies on various power generation technologies such as solar power, wind power, and tidal power are continuing, and power storage devices such as batteries for more efficiently using the generated electrical energy are also of great interest.

Furthermore, as technology development and demand for electronic mobile devices and electric vehicles using batteries increase, the demands for batteries as energy sources are rapidly increasing. Thus, many studies on batteries which are capable of meeting various demands have been conducted.

In particular, in terms of materials, there is a high demand for lithium secondary batteries such as lithium ion batteries and lithium ion polymer batteries having advantages such as high energy density, discharge voltage, and output stability.

The secondary batteries may be classified into, among others, cylindrical batteries and prismatic batteries, in which an electrode assembly is embedded in a cylindrical or prismatic metal can, and pouch-type batteries, in which an electrode assembly is embedded in a pouch-type case made of an aluminum laminate sheet, according to shapes of battery cases. Also, recently, due to the trend of smaller wearable devices, the importance of developing small batteries such as button type secondary batteries has been highlighted.

However, a button cell used in such a wearable device may be inevitably shaken much more during the use process. In this case, the conventional button cell has a problem in that the electrode assembly is shaken together inside the button cell. As described above, when the electrode assembly is shaken, there is a problem in that a portion, at which an electrode tab connected to an electrode of the electrode assembly is welded, to a can is easily separated to cause failure of a product.

Also, in the button cell, after the electrode assembly is inserted into the can body that is a battery can case, a base plate that is a cover having a plate shape is covered on an opening of the can body, and the can body and the base plate are laser-welded to each other. However, in the conventional button cell, there is a problem in that the separator of the electrode assembly ascends to the laser-welded portion between the can body and the base plate to cause an interference during the laser welding. This leads to defective products, which frequently occur because the button cell has a very small size.

### DISCLOSURE OF THE INVENTION

### Technical Objective

The present invention has been devised to solve the above problems, and an object of the present invention is to provide a button type secondary battery, in which an electrode assembly is pressed downward to improve fixability, thereby preventing the electrode assembly from being shaken in a cell, and thus, preventing a welded portion of an electrode tab from being separated. In addition, another object of the present invention is to provide a button type secondary battery, in which a separator ascends to be prevented from interfering with a laser-welded portion between a can body and a base plate.

### Technical Solution

A button type secondary battery according to the present invention relates to a button type secondary battery having a diameter greater than a height thereof, the button type secondary battery including an electrode assembly, in which electrodes and separators are alternately disposed; a can body into which the electrode assembly is inserted, a base plate in which a through-hole is formed and which covers an opening of an upper end of the can body and is bonded to the can body, an electrode terminal of which at least a portion is inserted into the through-hole of the base plate and which covers the through-hole, an insulating gasket configured to insulate the electrode terminal and the base plate from each other, and an insulating sheet disposed on a bottom surface of the base plate to insulate the base plate and the electrode assembly from each other, wherein the bottom surface of the insulating sheet is disposed closer to the electrode assembly than a bottom surface of the electrode terminal.

An edge of the base plate and the opening of the can body may be bonded to each other by laser welding.

The electrode terminal, the insulating gasket, and the base plate may be bonded to each other through thermal fusion.

The insulating sheet may be attached to the bottom surface of the base plate.

The insulating sheet may be attached to an entire surface facing the electrode assembly on the bottom surface of the base plate.

The insulating sheet may be disposed between an upper end of the outermost separator and a welding part, which is a portion coupled by laser welding, in the electrode assembly.

The insulating sheet may include a polymer-based sheet made of a PP or PET material.

The bottom surface of the insulating sheet may be configured to press an upper end of the separator provided in the electrode assembly.

The bottom surface of the electrode assembly may be in close contact with a bottom surface of the can body.

The electrode terminal may include: an insertion part inserted into the through-hole; and a terminal plate part extending outward from an upper end of the insertion part and extending to have a plate shape, wherein the bottom surface of the insulating sheet may be disposed closer to the electrode assembly than a bottom surface of the insertion part.

The insertion part may have a cross-sectional diameter, which gradually decreases as the insertion part descends in a direction closer to the electrode assembly.

The insulating sheet may have an insertion hole therein, and a lower end of the insertion part may be inserted into the insertion hole of the insulating sheet.

The electrode terminal may have a positive polarity, and each of the can body and the base plate may have a negative polarity.

A coating layer including a material that blocks heat may be formed on the bottom surface of the insulating sheet.

The material that blocks the heat may include ceramic.

The electrode assembly may include an electrode wound body, in which one or more positive electrodes, one or more negative electrodes, and one or more separators are wound on each other.

### Advantageous Effects

The button type secondary battery according to the present invention may relate to the button type secondary battery of which a diameter is greater than a length, i.e., the button type secondary battery, in which the electrode assembly is pressed downward to improve the fixability, thereby preventing the electrode assembly from being shaken in the cell, and thus, preventing the welded portion of the electrode tab from being separated. In addition, in the button type secondary battery according to the present invention, the separator may ascend to prevent the separator from interfering with the laser-welded portion between the can body and the base plate.

### BRIEF DESCRIPTION OF THE DRAWINGS

FIG. 1 is a cross-sectional view of a button type secondary battery according to Embodiment 1 of the present invention.

FIG. 2 is a cross-sectional view of a button type secondary battery according to Embodiment 2 of the present invention.

### MODES FOR CARRYING OUT THE INVENTION

Hereinafter, preferred example embodiments of the present invention will be described in detail with reference to the accompanying drawings so that those of ordinary skill in the art can easily carry out the present invention. However, the present invention may be implemented in several different forms and is not limited or restricted by the following examples.

In order to clearly explain the present invention, detailed descriptions of portions that are irrelevant to the description or related known technologies that may unnecessarily obscure the gist of the present invention have been omitted, and in the present specification, reference symbols are added to components in each drawing. In this case, the same or similar reference numerals are assigned to the same or similar elements throughout the specification.

Also, terms or words used in this specification and claims should not be restrictively interpreted as ordinary meanings or dictionary-based meanings, but should be interpreted as meanings and concepts conforming to the scope of the present invention on the basis of the principle that an inventor can properly define the concept of a term to describe and explain his or her invention in the best ways.

### Embodiment 1

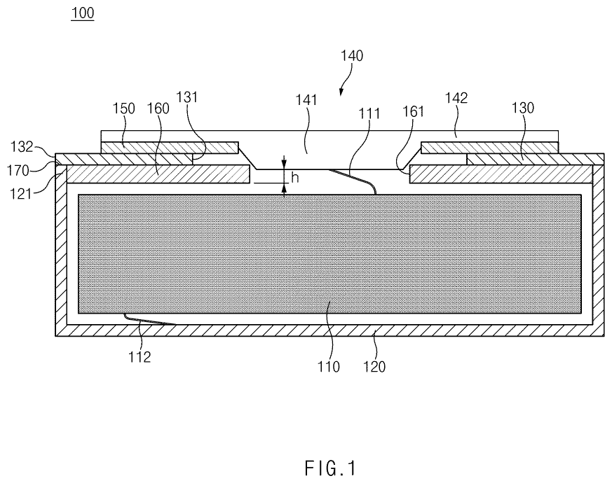

FIG. 1 is a cross-sectional view of a button type secondary battery according to Embodiment 1 of the present invention.

With reference to FIG. 1, a button type secondary battery 100 according to Embodiment 1 of the present invention may be a button-type secondary battery 100 of which a diameter is greater than a height. Also, the button type secondary battery 100 according to Embodiment 1 of the present invention may include an electrode assembly 110, a can body 120, a base plate 130, an electrode terminal 140, an insulating gasket 150, and an insulating sheet 160.

The electrode assembly 110 may be formed by alternately disposing a positive electrode, a separator, and a negative electrode. The electrode assembly 110 may be a jelly roll-type electrode assembly 110 in which the electrodes and the separator are alternately disposed and wound. The electrode assembly 110 may be an electrode wound body in which one or more positive electrodes, one or more negative electrodes, and one or more separators are wound on each other.

The can body 120 may have a configuration in which the electrode assembly 110 is inserted. The can body 120 may have an internal space, and the electrode assembly 110 may be vertically inserted into the internal space. The vertical insertion may mean that the electrode assembly is inserted so that a winding axis of the electrode assembly is perpendicular to a bottom part of the can body. The can body 120 may have an opening at an upper side thereof. That is, the can body 120 may be opened upward and include a bottom part and a sidewall.

The base plate 130 may cover an upper opening 121 of the can body 120 and be bonded to the can body 120. This bonding may be bonding using welding. Particularly, an edge 132 of the base plate and the opening 121 of the can body may be bonded to each other by laser welding. A portion at which the edge 132 of the base plate and the opening 121 of the can body are welded by welding may be a welding part 170.

Also, this type of laser welding may be seam welding that is advantageous for preventing a welding pin hole. In addition, a through-hole 131 may be formed in an inner center of the base plate 130. Here, the base plate may be made of a metal material, and the metal material may be at least one or more selected from SUS, nickel-plated carbon steel, and Al.

The electrode terminal 140 may be a terminal bonded to the through-hole 131 formed inside the base plate 130. The electrode terminal 140 may be a positive electrode terminal having a positive pole. This may be a result of the positive electrode of the electrode assembly 110 being connected to the electrode terminal 140. FIG. 1 illustrates a state in which the positive electrode tab 111 is connected to a bottom surface of the electrode terminal 140. This bonding may be bonding using the welding.

When the electrode terminal 140 has the positive pole, each of the can body 120 and the base plate 130 may have a negative pole. The negative electrode of the electrode assembly 110 may be connected to the can body 120 so that the can body 120 has the negative pole. As the base plate 130 is welded to the can body 120, the same negative pole as the can body 120 may be formed. FIG. 1 illustrates a state in which the negative electrode tab 112 is connected to the bottom surface of the electrode terminal 140. This bonding may be bonding using the welding.

At least a portion of the electrode terminal may be configured to be inserted into the through-hole 131 formed inside the base plate 130 so as to cover the through-hole 131. The electrode terminal 140 may be made of a metal material, and the metal material may be any one or more selected from SUS, nickel-plated carbon steel, and Al.

The insulating gasket 150 may be configured to insulate the electrode terminal 140 from the base plate 130. That is, the insulating gasket 140 may be configured to prevent short circuit from occurring between the electrode terminal 140 and the base plate 130. When the electrode terminal 140 has the positive pole, since the base plate 130 bonded to the body of the can body 120 that has a negative pole has a negative pole, and the electrode terminal 40 has a positive pole, a structure that insulates the electrode terminal 140 from the base plate is required. The structure is an insulating gasket 150.

In addition, the electrode terminal 140, the insulating gasket 150, and the base plate 130 may be bonded to each other by thermal fusion. In the related art, a rivet structure is used to couple the electrode terminal 140. However, in the button type secondary battery 100 according to Embodiment 1 of the present invention, a thermal fusion structure instead of the rivet structure may be used.

The insulating sheet 160 may be disposed on a bottom surface of the base plate 130 and may be configured to insulate the base plate 130 and the electrode assembly 110 from each other.

In addition, the insulating sheet 160 may be attached to the bottom surface of the base plate 130. When attached as described above, the insulating sheet 160 may be stably disposed without moving.

In addition, the insulating sheet 160 may be a polymer-based sheet including a PP or PET material. While the insulating sheet 160 is made of the PP or PET material, a thickness of the insulating sheet 160 may increase to be attached thereto.

With reference to FIG. 1, in the button type secondary battery 100 according to Embodiment 1 of the present invention, the bottom surface of the insulating sheet 160 may be disposed closer to the electrode assembly 110 than the bottom surface of the electrode terminal 140. When formed as described above, a height difference occurs between the bottom surface of the insulating sheet 160 and the bottom surface of the electrode terminal 140. This height difference is indicated by reference symbol h in FIG. 1. When viewed from below, this may be a shape in which the electrode terminal 140 is recessed.

Due to this structure, i.e., a shape in which the bottom surface of the insulating sheet 160 is disposed closer to the electrode assembly 110 than the bottom surface of the electrode terminal 140, the bottom surface of the insulating sheet 160 may press an upper end of the separator provided in the electrode assembly 110. In addition, the bottom surface of the electrode assembly 110 may be in close contact with the bottom surface of the can body 120. Thus, fixability of the electrode assembly 110 may be improved.

(For reference, in FIG. 1, the bottom surface of the electrode assembly 110 is illustrated so as not to be in close contact with the bottom surface of the can body 120, that is, this is only illustrated as not in close contact for convenience so as to illustrate the negative electrode tab 112 and does not mean that the negative electrode tab 112 is actually not in close contact.)

As described above, in the button type secondary battery 100 according to Embodiment 1 of the present invention, the electrode assembly 110 may be pressed downward to improve the fixability, thereby preventing the electrode assembly 110 from being shaken inside the cell. Therefore, stability and safety of the button type secondary battery 100 may be secured, and also, the welded portion of the electrode tab (the positive electrode tab 111 or the negative electrode tab 112) may not be separated.

In more detail, in the button type secondary battery 100 according to Embodiment 1 of the present invention, the electrode terminal 140 may include an insertion part 141 inserted into the through-hole 131 and a terminal plate part 142 extending outward from an upper end of the insertion part 141 and extending to have a plate shape. In addition, in this specific structure, it may be expressed that a bottom surface of the insulating sheet 160 is disposed closer to the electrode assembly 110 than the bottom surface of the insertion part 141.

Here, the insertion part 141 may have a shape of which a cross-sectional diameter gradually decreases as the insertion part 141 descends in a direction closer to the electrode assembly 110. An insertion hole 161 may be formed inside the insulating sheet 160. In this case, a lower end of the insertion part 141 may be inserted into the insertion hole 161 of the insulating sheet 160. When having such a structure, the lower end of the insertion part 141 may not be in contact with the insulating sheet 160. That is, the lower end of the insertion part 141 may not touch or press the insulating sheet 160, and thus, the insulating sheet 160 may be stably attached to the base plate 130.

In the button type secondary battery 100 according to Embodiment 1 of the present invention, the insulating sheet 160 may be attached to the entire surface of the bottom surface of the base plate 130 facing the electrode assembly 110. Thus, it may serve to stably press the electrode assembly 110 downward on the entire surface. In addition, the insulating sheet 160 may be disposed between an upper end of the outermost separator in the electrode assembly 110 and the welding part 170, which is a portion coupled by the laser welding.

In this case, the separator may ascend to be prevented from interfering with the laser-welded portion between the can body 120 and the base plate 130. That is, since the insulating sheet 160 is formed to be thick so as to more downwardly press the separator of the electrode assembly 110, the problem of welding defects caused by interference with the separator in the welding part 170 may be solved.

### Embodiment 2

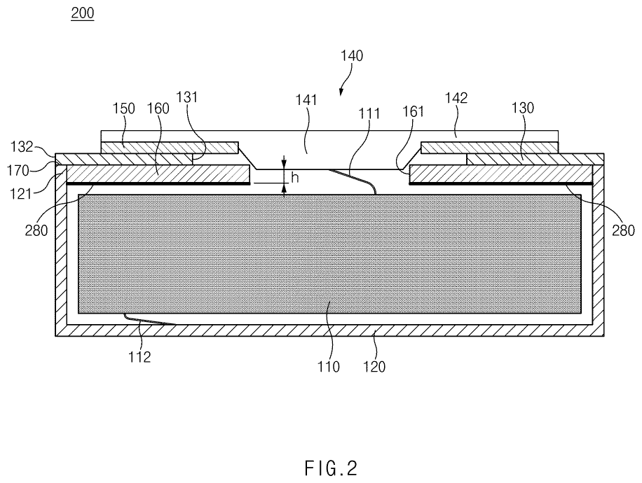

FIG. 2 is a cross-sectional view of a button type secondary battery according to Embodiment 2 of the present invention.

Embodiment 2 of the present invention is different from Embodiment 1 in that a coating layer 280 including a material for blocking heat is formed on a bottom surface of an insulating sheet 160.

The contents that are duplicated with Embodiment 1 will be omitted as much as possible, and Embodiment 2 will be described with a focus on the differences. That is, it is obvious that contents that are not described in Embodiment 2 may be regarded as the contents of Embodiment 1 if necessary.

With reference to FIG. 2, in a button type secondary battery 200 according to Embodiment 2 of the present invention, the coating layer 280 including the material for blocking heat may be formed on the bottom surface of the insulating sheet 160. Here, the material for blocking the heat, which is provided in the coating layer 280, may be ceramic. For example, the ceramic coating layer 280 may be formed on the bottom surface of the insulating sheet 160.

When formed in this structure, the insulating sheet 160 may be protected even when high-temperature heat is generated inside the button type secondary battery 200. That is, even when the high-temperature heat is generated, the insulating sheet 160 may not be melted or be damaged. Therefore, short circuit may be prevented, and safety of the battery may be secured.

While the example embodiments of the present invention have been described with reference to the specific example embodiments, it will be apparent to those skilled in the art that various changes and modifications may be made without departing from the spirit and scope of the invention as defined in the following claims.

### DESCRIPTION OF THE SYMBOLS

100, 200: Button type secondary battery
110: Electrode assembly
111: Positive electrode tab
112: Negative electrode tab
120: Can body
121: Opening of can body
130: Base plate
131: Through-hole
132: Edge of base plate
140: Electrode terminal
141: Insertion part
142: Terminal plate part
150: Insulating gasket
160: Insulating sheet
161: Insertion hole
170: Welding part
280: Coating layer

1. A button type secondary battery having a diameter greater than a height thereof, the button type secondary battery comprising:
an electrode assembly, in which electrodes and separators are alternately disposed;
a can body housing the electrode assembly;
a base plate including a through-hole and covering an opening at an upper end of the can body, the base plate being bonded to the can body;
an electrode terminal covering the through-hole of the base plate, at least a portion of the electrode terminal being inserted into the through-hole of the base plate;
an insulating gasket configured to insulate the electrode terminal and the base plate from each other; and
an insulating sheet disposed on a bottom surface of the base plate to insulate the base plate and the electrode assembly from each other,
wherein the bottom surface of the insulating sheet is disposed closer to the electrode assembly than a bottom surface of the electrode terminal is.

2. The button type secondary battery of claim 1, wherein an edge of the base plate and the upper end of the can body are bonded to each other by laser welding.

3. The button type secondary battery of claim 1, wherein the electrode terminal, the insulating gasket, and the base plate are bonded to each other through thermal fusion.

4. The button type secondary battery of claim 1, wherein the insulating sheet is attached to the bottom surface of the base plate.

5. The button type secondary battery of claim 1, wherein the insulating sheet is attached to an entire bottom surface of the base plate facing the electrode assembly.

6. The button type secondary battery of claim 2, wherein the insulating sheet is disposed between an upper end of an outermost separator among the separators in the electrode assembly and a welding part, which is a portion of the base plate and the upper end of the can body coupled by laser welding.

7. The button type secondary battery of claim 1, wherein the insulating sheet comprises a polymer-based sheet made of a polypropylene (PP) or polyethylene terephthalate (PET) material.

8. The button type secondary battery of claim 1, wherein the bottom surface of the insulating sheet is configured to press an upper end of a separator among the separators provided in the electrode assembly.

9. The button type secondary battery of claim 8, wherein the bottom surface of the electrode assembly is in close contact with an internal bottom surface of the can body.

10. The button type secondary battery of claim 1, wherein the electrode terminal comprises:
an insertion part inserted into the through-hole of the base plate; and
a terminal plate part extending outward from an upper end of the insertion part and extending to have a plate shape,
wherein the bottom surface of the insulating sheet is disposed closer to the electrode assembly than a bottom surface of the insertion part is.

11. The button type secondary battery of claim 10, wherein the insertion part has a cross-sectional diameter, which gradually decreases in a direction closer to the electrode assembly.

12. The button type secondary battery of claim 10, wherein;
the insulating sheet has an insertion hole therein, and
a lower end of the insertion part is inserted into the insertion hole of the insulating sheet.

13. The button type secondary battery of claim 1, wherein:
the electrode terminal has a positive polarity, and
each of the can body and the base plate has a negative polarity.

14. The button type secondary battery of claim 1, wherein a coating layer is formed on the bottom surface of the insulating sheet, the coating layer comprising a material for blocking heat.

15. The button type secondary battery of claim 14, wherein the material for blocking heat comprises ceramic.

16. The button type secondary battery of claim 1, wherein the electrode assembly comprises an electrode wound body, in which one or more positive electrodes and one or more negative electrodes among the electrodes and the separators are wound on each other.
